(19) United States
(12) Patent Application Publication
(10) Pub. No.: US 2006/0120541 A1
(43) Pub. Date: Jun. 8, 2006

(54) Combined microphone-loudspeaker

(76) Inventor: Prakash Teshwant Bhandare, Ang Mo Kio Avneue- 3 (SG)

Correspondence Address: PHILIPS INTELLECTUAL PROPERTY & STANDARDS, P.O. BOX 3001, BRIARCLIFF MANOR, NY, 10510, US

(21) Appl. No.: 10/559,562

(22) PCT Filed: May 26, 2004
(86) PCT No.: PCT/IB04/50777

§ 371 Date: Dec. 2, 2005

(30) Foreign Application Priority Data
Jun. 5, 2003 (EP) 031016421

(51) Int. Cl. H04R 3/00; H04R 29/00

(52) U.S. Cl. 381/111; 381/59; 381/96

(57) ABSTRACT

Assembly for generating and recording sound, comprising an electromagnetic transducer (1) for transforming electrical energy into acoustical energy, wherein the assembly comprises at least one microphone (2), wherein at least part of said microphone (2) is located within said transducer (1). The invention further provides an apparatus for generating and recording sound, for instance a loudspeaker system, comprising at least one such assembly. Besides, the invention provides the use of at least one such assembly, as well as a transducer (1).

The invention relates to an assembly for generating and recording sound, comprising an electromagnetic transducer for transforming electrical energy into acoustical energy, wherein the assembly comprises at least one microphone.

Such an assembly is known from the Japanese patent application JP 200175279. The known assembly comprises a transducer and a microphone which are stacked onto each other, in particular to attain miniaturization to make the size of a portable radio terminal small. During use, the transducer generates sound, for example for voice generation. The microphone serves for recording sound.

A problem of the known assembly is, that it still requires a relatively large amount of space. It is an object of the present invention to solve this problem, in particular so that the assembly for generating and recording sound requires relatively little amount of space.

The present invention provides an assembly which is characterised in that at least part of said microphone is located within said transducer.

Thus, the at least one microphone is at least partially integrated in the transducer, resulting in a relatively compact assembly. The assembly according to the invention allows a high degree of miniaturization, wherein the interior of the transducer is used very efficiently by receiving at least part of said microphone. Each assembly can be offered and sold as one component, in particular as the electromagnetic transducer comprising the at least one microphone, so that the installation of the transducer leads to the simultaneous installation of said microphone. The present invention is based on the inventive notion that one or more microphones can be located at least partially within an electromagnetic transducer instead of outside the transducer, the latter being general practice in the prior art until the present day.

Preferably, said microphone is located substantially within the transducer, so that the outer dimensions of the overall assembly is substantially determined by the dimensions of the transducer. This provides the further advantage that only the dimensions of the transducer have to be taken into account when mounting the assembly in a certain appliance, without having to reserve space for said microphone. Besides, this makes elaborate mounting arrangements, known from the art for mounting microphones and transducers separate from each other, redundant.

A further advantage of the assembly according to the invention is, that the quality of the sound recorded by the microphone can be of a relatively high standard. Furthermore, by locating the microphone in a suitable position, the microphone will not, or only slightly, interfere with the operation of the transducer, resulting in the transducer being able to produce sound of a desired high quality.

The invention also relates to a transducer for transforming electrical energy into acoustical energy, wherein at least a part of a microphone is located within the transducer.

The invention further provides an apparatus for generating and recording sound, comprising at least one assembly according to any of the claims 1-15. This apparatus benefits from the abovementioned advantages of the assembly according to the invention. The apparatus may involve various types of appliances, comprising or being part of, for instance, a loudspeaker system, a portable device, and/or a communication device.

According to the invention, it is also advantageous to use at least one assembly according to any of claims 1-15, wherein sound is recorded by said microphone, for example when relatively little space is available.

The invention further relates to the use of at least one assembly according to the invention. The use of the assembly according to the invention is defined in the claims 17 to 20.

With reference to the claims, it is to be noted that various combinations of characteristic features defined in the set of claims are possible.

The invention will now be described in more detail on the basis of an exemplary embodiment shown in the accompanying drawing.

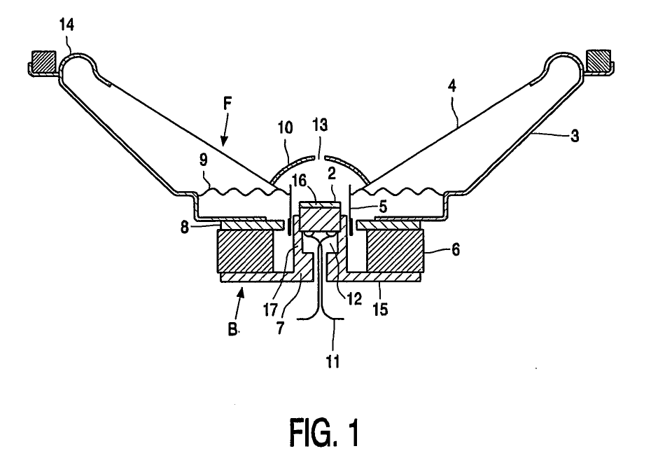

FIG. 1 is a cross-section of a preferred embodiment of the invention.

FIG. 1 shows an assembly, comprising a transducer 1 and a microphone 2. The transducer 1 has a front side F and a back side B. Said transducer front side F comprises a sound generating element 4. In the present embodiment, this element comprises an annular cone 4. The cone 4 is concentric with respect to the centre line z of the transducer 1. The transducer 1 comprises a front frame means 14 retaining said cone 4 in position by the outer edge of the cone 4. The cone 4 is provided with a central cap 10, extending over a central aperture of the annular cone 4, to shield the interior of the transducer 1 from the surroundings thereof. The transducer 1 also comprises a voice coil 5 which is attached to the inner cone edge for actuating said cone 4. Said coil 5 extends concentrically around the centre line z of the transducer 1.

The transducer further comprises a magnet 6, said voice coil 5 and magnet 6 being arranged to cooperate with each other for the actuation of the cone 4. In the present embodiment, said magnet is a relatively simple permanent magnet 6 which is positioned at a certain distance around a magnet core 7, said core 7 extending along said transducer centre line z. A front side of said magnet 6, this front side facing towards said transducer front side F, comprises an annular front plate 8. Part of said core 7 extends through a central aperture of this front plate 8. Said voice coil 5 extends axially through an annular slit provided between the front plate 8 and the magnet core 7. A back side of the magnet 6 comprises a back frame in the shape of a back plate 15, which is integrally connected to said core 7. This back plate 15 provides said transducer back side B.

The transducer 1 further comprises a rotation-symmetrical basket 3, an inner edge of which is attached to said magnet front plate 8, whilst the outer edge of said basket 3 is attached to said transducer front frame 14 for upholding this frame 14 in position with respect to the magnet front plate 8. The cone 4 and the voice coil 5 are connected to said basket 3 via spring means 9, also knows as spiders, for returning the cone 4 and the voice coil 5 to a certain idle position during use. Said spring means 9 also provides for a concentric movement of the voice coil with respect to the magnet core 7.

During use of the transducer 1, an electrical signal is provided to said voice coil 5, in particular by electrical wires not shown in the drawing. As a result, electromagnetically induced forces arise between the voice coil 5 and the magnet 6, leading to movement of the coil 5 and the cone 4 connected thereto, resulting in sound producing cone vibrations, or, in other words, acoustical energy.

The assembly 1 further comprises a microphone 2 which is positioned inside the transducer 1. Said microphone 2 is located on the centre line z of the transducer 1, at a certain distance behind the cap 10 of the transducer cone 4. The cap 10 shields the microphone 2 from the transducer environment, for instance to protect the microphone 2 against certain potentially harmful influences from the environment, such as dust and/or certain mechanical influences. The cap 10 comprises at least one air passage 13 for bringing said microphone 2 into contact with air surrounding the transducer 1. Said air passage provides a certain degree of venting of the space comprising the microphone 2, in order to facilitate incoming sound waves to reach the microphone 2. Therefore, the microphone 2 can record incoming sound with relatively high quality.

Particularly, said microphone 2 is attached to the magnet core 7 of said magnet 6. To this aim, a front side of said core 7, facing towards said front side F of the transducer 1, is provided with a microphone cavity 12 containing a back part of said microphone 2. The microphone 2 is firmly attached to the magnet core wall 17 surrounding this microphone aperture 12, for instance using adhesive means or other suitable means. Consequently, undesired vibrations of the microphone 2 are prevented or diminished. The microphone cavity 12 is surrounded by a rotational-symmetrical, particularly cylindrical, part 17 of said magnet core 7, said rotation-symmetry providing concentric movement of said voice coil 5 during use of the transducer 1. Said microphone 2 is partially surrounded by said voice coil 5. However, a sound receiving front part 16 of said microphone 2 is located at a certain distance from the magnet 6, in particular outside the area enclosed by both said voice coil 5 and said magnet core 7. Because of said location, the sound receiving part 16 of the microphone 2 is affected relatively little by the magnetic field of the magnet 6, resulting in a desired functioning of the microphone 2. The microphone 2 is connected to electrical wires 11, preferably comprising a shielded cable, extending through said core 7 for connecting the microphone 2 to outside equipment, for instance for recording and/or measuring a microphone signal.

The assembly 1, 2 is capable of recording sound, using the microphone 2. The assembly 1, 2 is of a relatively simple and cheap construction, particularly because of the application of a cone 4 which is actuated by a coil 5. Furthermore, the assembly 1, 2 is compact and can be installed with ease in many different appliances.

Some appliances of the assembly 1, 2 are: audio systems with MIC recording facilities, for example portable, mono and/or stereo players, walkmans et cetera. Other appliances are, for instance, self calibrating audio systems where a microphone is used to capture the dynamic transfer function of a surroundings, wherein one or more amplifier transfer functions are modified according to the microphone signal or according to said dynamic transfer function to acquire a certain desired sound field.

During the recording of sound, using the assembly 1, 2 of the invention, sound may be produced, for instance, by the respective transducer of the same assembly and/or by an other transducer, which does not comprise said sound recording microphone. Then, the at least one microphone 2 of the assembly 1, 2 can record sound produced by one or more of said transducers. The sound recorded by said microphone 2 may be used to adjust the sound generated by said transducer(s), for instance utilizing feed back means. In this way, a very precise calibration, for example of a high fidelity sound system, can be achieved without having to install one or more separate microphones.

Although the illustrative embodiment of the present invention has been described in greater detail with reference to the accompanying drawing, it is to be understood that the invention is not limited to that embodiment. Various changes or modifications may be effected by one skilled in the art without departing from the scope or the spirit of the invention as defined in the claims.

The assembly may, for instance, be used in many different types of appliances, for example in audio and/or video systems, video monitors, loudspeaker systems, telephones, portable audio devices, video cameras, computer systems, audio calibration feedback systems, audio cassette players, surveillance systems, communication devices, computers, handheld communicators, in combinations of these appliances and/or in other appliances.

Furthermore, part of the microphone may, for example, be provided in and/or extend through an outer side of the transducer 1.

Besides, said air passage 13 in the dust cap 10 can be obtained in different ways for bringing said microphone 2 into contact with ambient air. The cap 10 may, for example, comprise many small air passages and/or comprise porous material, for instance fabric.

The sound generating element 4 can be provided in different ways and shapes, for instance as a cone, a membrane, and/or a thin plate.

The assembly may also be provided with more than one microphone.

1. Assembly for generating and recording sound, comprising an electromagnetic transducer (1) for transforming electrical energy into acoustical energy, wherein the assembly comprises at least one microphone (2), wherein at least part of said microphone (2) is located within said transducer (1).

2. Assembly according claim 1, wherein said microphone (2) is positioned substantially within said transducer (1).

3. Assembly according to claim 1, wherein an outer surface (F) of said transducer (1) comprises at least one air passage (13) for bringing said microphone (2) into contact with ambient air.

4. Assembly according to claim 1, wherein the transducer (1) comprises a coil (5) for actuating a sound generating element (4).

5. Assembly according to claim 4, wherein said microphone (2) is at least partially surrounded by said coil (5).

6. Assembly according to at least claim 4, wherein said sound generating element comprises a cone (4).

7. Assembly according to claim 6, wherein said cone (4) comprises a central cap (10), wherein said microphone (2) is located behind said cap (10).

8. Assembly according to claim 4, wherein the transducer (1) comprises a magnetic means (6) for cooperation with said coil (5) for the actuation of the sound generating element (2), wherein said microphone (2) is connected to said magnetic means (6).

9. Assembly according to claim 8, wherein said magnetic means comprises a magnet core (7), wherein said microphone (2) is attached to said core (7).

10. Assembly according to claim 9, wherein said coil (5) partly surrounds said magnet core (7).

11. Assembly according to claim 9, wherein said magnet core (7) is provided with a microphone aperture (12) containing at least part of said microphone (2).

12. Assembly according to claim 11, wherein a sound receiving part (16) of said microphone (2) is located outside the area which is enclosed by both said coil (5) and said magnet core (7).

13. Assembly according to claim 11, wherein said microphone aperture (12) is surrounded by a substantially rotation-symmetrical part (17) of said core (7).

14. Assembly according to claim 9, wherein said microphone (2) is connected to electrical wire means (11) extending through said magnet core (7).

15. Assembly according to claim 1, wherein said microphone (2) is located on the centre line (z) of the transducer (1).

16. Apparatus for generating and recording sound, comprising the assembly according to claim 1.

17. Use of the assembly according to claim 1, wherein sound is recorded by said microphone (2) of said assembly (1, 2).

18. Use according to claim 17, wherein, at the same time, sound is produced by the respective transducer (1) of the same assembly (1, 2).

19. Use according to claim 18, wherein the sound recorded by said microphone (2) of said assembly (1, 2) is used to adjust the sound generated by said transducer, for instance by utilizing feed back means.

20. Use according to claim 17, wherein the sound recorded by the microphone (2) of the assembly (1, 2) is used to calibrate at least one amplifier transfer function.
